(19) United States
(12) Patent Application Publication
(10) Pub. No.: US 2025/0139945 A1
(43) Pub. Date: May 1, 2025

(54) METHOD AND APPARATUS WITH DATA AUGMENTATION

(71) Applicant: Samsung Electronics Co., Ltd., Suwon-si (KR)

(72) Inventors: Kyuhyun SHIM, Suwon-si (KR); Seongeun KIM, Suwon-si (KR); Seohyung LEE, Suwon-si (KR)

(73) Assignee: Samsung Electronics Co., Ltd., Suwon-si (KR)

(21) Appl. No.: 18/663,547

(22) Filed: May 14, 2024

(30) Foreign Application Priority Data
Oct. 31, 2023 (KR) 10-2023-0148012

(51) Int. Cl. G06V 10/774; G06T 5/50; G06T 5/77; G06V 10/26; G06V 10/764; G06V 10/82

(52) U.S. Cl. CPC G06V 10/774; G06T 5/50; G06T 5/77; G06V 10/26; G06V 10/764; G06V 10/82; G06T 2207/10028; G06T 2207/20081; G06T 2207/20084; G06T 2207/20212

(57) ABSTRACT

A method and apparatus with data augmentation are disclosed. The a method includes: based on information about objects included in target data, extracting a region for object synthesis from a point cloud of the target data; determining a target object based on location information about the extracted region; based on a point cloud of the target object and the point cloud of the target data, synthesizing the point cloud of the target object with the extracted region to generate a synthetic point cloud; and generating a synthetic image by synthesizing an image of the target object with an image of the target data based on the location information about the extracted region and the point cloud of the target object, wherein the synthetic point cloud and the synthetic image form an augmented training item.

### CROSS-REFERENCE TO RELATED APPLICATIONS

This application claims the benefit under 35 USC § 119(a) of Korean Patent Application No. 10-2023-0148012, filed on Oct. 31, 2023, in the Korean Intellectual Property Office, the entire disclosure of which is incorporated herein by reference for all purposes.

### BACKGROUND

### 1. Field

The following description relates to a method and apparatus with data augmentation.

### 2. Description of Related Art

Lack of sufficient training data during the learning process of neural network-based models may affect the convergence speed of learning and the performance of models. When training data is insufficient, data augmentation technology may be used to augment training data. For example, training data may be augmented by generating new data by combining different pieces of data included in training data with each other or by transforming data included in training data using techniques such as rotation and color change.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments include technology that augments training data by, for example, naturally synthesizing an image of an object corresponding to a class in which a training data set is insufficient and a point cloud.

However, the technical aspects are not limited to the aforementioned aspects, and other technical aspects may be present.

In one general aspect, a method of augmenting data performed by a computing device includes: based on information about objects included in target data, extracting a region for object synthesis from a point cloud of the target data; determining a target object based on location information about the extracted region; based on a point cloud of the target object and the point cloud of the target data, synthesizing the point cloud of the target object with the extracted region to generate a synthetic point cloud; and generating a synthetic image by synthesizing an image of the target object with an image of the target data based on the location information about the extracted region and the point cloud of the target object, wherein the synthetic point cloud and the synthetic image form an augmented training item.

The region may be extracted from the point cloud of the target data based on segmentation information about the point cloud of the target data.

The extracting of the region may include: determining a class of an object to be synthesized with the target data; and extracting a region for object synthesis from the target data based on locations of objects included in the target data that are associated with the determined class.

The location information about the extracted region may include coordinate information, rotation information, and size information about the extracted region.

The determining of the target object may include, among objects of which a point cloud and location information are stored in a database, selecting, to be the target object, an object based on the object having location information that corresponds to the location information about the extracted region.

The location information about the object stored in the database may include distance information and angle information from an ego.

The determining of the target object may include correcting location information about the target object by rotationally transforming the location information about the target object based on the location information about the extracted region, an angle between a first vector and a progress vector of the target object and distance information between the target object and the ego may correspond to the location information about the extracted region, and the first vector may be defined by a reference location of an ego and a reference location of the target object.

The synthesizing of the image of the target object with the image of the target data may be based on the image of the target data, the image of the target object, and the point cloud of the target object.

The synthesizing of the image of the target object with the image of the target data may include: determining an in-painting region in the image of the target data based on the location information about the extracted region; and synthesizing the image of the target object with the in-painting region based on the point cloud of the target object.

The determining of the in-painting region in the image of the target data may include determining a region, corresponding to the extracted region, in the image of the target data to be the in-painting region based on a coordinate obtained by projecting a coordinate of a point cloud of the extracted region based on the image of the target data.

The method may further include: generating at least one of a synthetic point cloud generated by synthesizing the point cloud of the target object with the point cloud of the target data or a synthetic image generated by synthesizing the image of the target object with the image of the target data as training data of a neural network.

A non-transitory computer-readable storage medium may store instructions that, when executed by a processor, cause the processor to perform any of the methods.

In another general aspect, an apparatus for augmenting training data includes: one or more processors: memory storing instructions configured to cause the one or more processors to: based on information about objects included in target data, extract a region for object synthesis from a point cloud of the target data; determine a target object based on location information about the extracted region; based on a point cloud of the target object and the point cloud of the target data, synthesize the point cloud of the target object with the extracted region to generate a synthetic point cloud; and generate a synthetic image by synthesizing an image about the target object with an image of the target data based on the location information about the extracted region and the point cloud of the target object, wherein the synthetic point cloud and the synthetic image form an augmented training item.

The instructions may be further configured to cause the one or more processors to extract the region from the point cloud of the target data based on segmentation information about the point cloud of the target data.

The instructions may be further configured to cause the one or more processors to, in the extracting of the region: determine a class of an object to be synthesized with the target data; and extract a region for object synthesis from the target data based on locations of objects included in the target data that are associated with the determined class.

The instructions may be further configured to cause the one or more processors to, in the determining of the target object, among objects of which a point cloud and location information are stored in a database, select, to be the target object, an object based on the object having location information that corresponds to the location information about the extracted region.

The instructions may be further configured to cause the one or more processors to, in the determining of the target object, correct location information about the target object by rotationally transforming the location information about the target object based on the location information about the extracted region, an angle between a first vector and a progress vector of the target object and distance information between the target object and the ego may correspond to the location information about the extracted region, and the first vector may be defined by a reference location of an ego and a reference location of the target object.

The instructions may be further configured to cause the one or more processors to, in the synthesizing of the image of the target object with the image of the target data: determine an in-painting region in the image of the target data based on the location information about the extracted region; and synthesize the image of the target object with the in-painting region based on the point cloud of the target object.

The instructions may be further configured to cause the one or more processors to, in the determining of the in-painting region in the image of the target data, determine a region corresponding to the extracted region in the image of the target data to be the in-painting region based on a coordinate obtained by projecting a coordinate of a point cloud of the extracted region based on the image of the target data.

The instructions may be further configured to cause the one or more processors to generate at least one of a synthetic point cloud generated by synthesizing the point cloud of the target object with the point cloud of the target data or a synthetic image generated by synthesizing the image of the target object with the image of the target data as training data of a neural network.

Other features and aspects will be apparent from the following detailed description, the drawings, and the claims.

### BRIEF DESCRIPTION OF THE DRAWINGS

FIG. 1 illustrates an example data augmentation method, according to one or more embodiments.

FIG. 2 illustrates an example of an angle between a vector defined by a reference location of an ego and a reference location of a target object, and a motion vector of the target object, according to one or more embodiments.

FIG. 3 illustrates an example module of an apparatus for performing the data augmentation method, according to one or more embodiments.

FIG. 4 illustrates an example object bank, according to one or more embodiments.

FIG. 5 illustrates an example point cloud generation module, according to one or more embodiments.

FIG. 6 illustrates an example image generation module, according to one or more embodiments.

FIG. 7 illustrates an example data augmentation apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

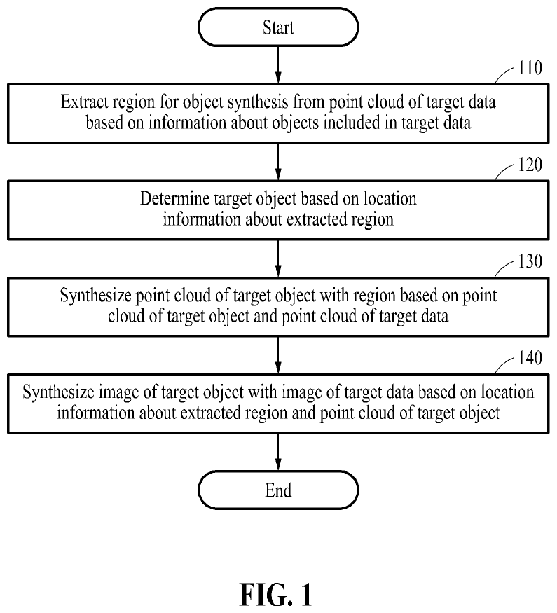

FIG. 1 illustrates an example data augmentation method, according to one or more embodiments.

Referring to FIG. 1, the data augmentation method may include operation 110 of extracting, from a point cloud of target data, a region for object synthesis, where the region is extracted based on information about objects included in the target data.

The target data may include the point cloud and an image. The target data's point cloud and image may be pieces of data that correspond to each other. For example, the image may be obtained by projecting at least a portion of the point cloud onto an arbitrary two-dimensional (2D) plane. For example, the image and the point cloud may correspond to data obtained by respective sensors installed at the same locations as, adjacent to, or similar to each other (typically, fixed with respect to each other). For example, the image and the point cloud of the target data may each correspond to data obtained by a camera and a light detection and ranging (LiDAR) sensor installed in the same vehicle (other suitable sensors may be used). Since the target data includes one or more types of pieces of data corresponding to each other, the target data may characterized as multi-domain data.

The region is a region including at least a portion of the point cloud of the target data, and may include, for example, a three-dimensional (3D) bounding box. The region is a region where a target object is synthesized (e.g., combined, merged, etc.) and may be determined based on information about object(s) included in the region and/or information about the target object to be synthesized.

Operation 110 of extracting the region may include extracting a region from the point cloud of the target data based on segmentation information about the point cloud of the target data (e.g., point cloud segments). For example, based on the segmentation information about the point cloud, a plane (e.g., on the driveway, on the sidewalk, etc.) may be recognized, where the plane may be a surface/object upon which the target object may reside (rest upon, etc.), and a partial region that includes the plane may be extracted.

Operation 110 of extracting the region may include (i) determining an object class of an object that is to be synthesized based on the target data and (ii) extracting a region for object synthesis from the target data based on locations of objects included in the target data that correspond to (e.g., belong to) the object class.

The object class may be determined to be an object class required for training data. For example, given an evaluation result of a mean average precision (mAP) of a learning model using a training data set, a class with a low mAP may be determined to be the object class (that is to be synthesized based on the target data). For example, an object class less frequently included in the training data set may be determined to be the object class to be synthesized with the target data.

For example, when there are fewer images or point clouds including an object of a ‘truck’ class the training data set (e.g., for training a model for autonomous driving), the ‘truck’ class may be determined to be the object class to be synthesized with the target data. When the object class is determined to be a ‘truck,’ a region corresponding to ‘on the driveway’ of the point cloud (a region on which the object of the ‘truck’ class may be placed/resting) may be extracted from the target data to serve as a region for object synthesis.

The data augmentation method may include operation 120 of determining the target object based on location information about the extracted region.

The target object may be obtained from a database that stores information about objects. The target object may be determined from among objects in the database. The database may store information (e.g., records) about objects. The information about the objects may include, for each respective object (record), a point cloud of the object, an image of the object, class information about the object (an indication of one or more classes of the object), and/or location information about the object. The location information about the object stored in the database may include distance information from an ego (e.g., ego vehicle) and angle information with the ego (location relative to the ego). For example, the location information about an object stored in the database may include a distance value from the location of the ego to the location of the object. For example, the location information about an object stored in the database may include an angle value from the location of the ego to the location of the object. The location information about an object stored in the database may include rotation information about the object. The rotation information about an object may include a value indicating the degree to which a phase of an object rotates when compared with a predetermined reference phase in response to the object. For example, the rotation information may include a value indicating the degree to which three axes rotate.

The database may store information (e.g., a record) about at least one object for each class. For example, the database may store information about at least one object corresponding to a ‘passenger car’ class, information about at least one object corresponding to a ‘truck’ class, and information about at least one object corresponding to a ‘pedestrian’ class. The information about the at least one object may be obtained from the training data set including the target data. The training data set may include at least one piece of data (record or training item) including a point cloud and an image corresponding to the point cloud. The target data may correspond to one piece of data (record or item) included in the training data set.

The location information about the extracted region indicates the location of the extracted region, and the location of the extracted region may include, for example, coordinate information, rotation information, and/or size information about the extracted region.

The coordinate information about the extracted region may include coordinate information corresponding to the extracted region when a space where the point cloud of the target data is placed is represented by a certain coordinate system. For example, the coordinate information about the extracted region may include coordinate information about the point cloud included in the extracted region. For example, the coordinate information about the extracted region may include coordinate information about a point (e.g., a vertex) to specify the extracted region.

The coordinate information about the extracted region may include a 3D coordinate value determined based on the location of the ego. The ego may refer to a sensor (e.g., a LIDAR sensor or an RGB-D sensor) (or object including same) to obtain a point cloud of other objects. For example, the space where the point cloud of target data is placed may be represented by a 3D orthogonal coordinate system with a position of the ego as the origin, and the coordinate information about the extracted region may include a coordinate value according to the 3D orthogonal coordinate system.

The rotation information about the extracted region may include rotation information about an object included in the region. For example, the rotation information about the extracted region may indicate the degree to which the phase (pose) of the object included in the extracted region is rotated relative to a predetermined reference phase/pose; the rotation information may be determined in response to the object being included in the region. For example, the rotation information may include a value indicating the degree of rotation about three axes.

The size information about the extracted region may include a value indicating the size of the extracted region, for example, the length (e.g., values of width, depth, and height) of the three axes/dimensions in the extracted region.

Operation 120 of determining the target object may include determining an object corresponding to the location information (location information about the extracted region to be the target object) among the objects in the database (objects having respective point cloud and the location information in the database). The object corresponding to the location information about the extracted region may have a locational relationship relative to the ego in the extracted region. For example, regarding determining the target object, when an object of a ‘driveway’ included in the extracted region is n-distance away from the ego and forms an m-angle with the ego, among the objects stored in the database, an object may be determined to be the target object when it has either (i) a value corresponding to the difference in which the distance from the ego to the object and a value n are less than or equal to a threshold value or (ii) having a value corresponding to the difference in which the angle between the ego and the object and a value m are less than or equal to a threshold value.

The object corresponding to the location information about the extracted region may be an object corresponding to the rotation information about the extracted region. That is to say, the object having the rotation information corresponding to the degree to which the object included in the extracted region is rotated may be determined to be the target object. For example, according to the rotation information about the object of a ‘driveway’ class included in the extracted region, an object of a class such as a ‘passenger car’ or ‘truck’ of which the progress (movement) direction is the same as or similar to the direction of the object of a ‘driveway’ class may be determined to be the target object.

To describe operation 120, some modelling elements are noted first. A vector defined by (between) (i) a reference location (e.g., center) of the ego and (ii) a reference location (e.g., center) of an object will be referred to as an “ego-object vector” (e.g., “ego-target-object vector”). A direction of progress/motion of an object will be referred to as an “object motion vector” (e.g., target-object motion vector). A distance between an object and the ego will be referred to as an “ego-object distance” (e.g., ego-target-object distance).

Operation 120 of determining the target object may include correcting the location information about the target object by rotationally transforming the location information about the target object based on the location information about the extracted region. The location information about the extracted region may include (A) an angle and (B) a distance. The angle (A) may be an angle between (i) the ego-target-object vector and (ii) the target-object motion vector. The distance (B) may be a an ego-target-object distance (a distance between the target object and the ego). Hereinafter, the angle between the ego-target-object vector and the target-object motion vector may be referred to as θ.

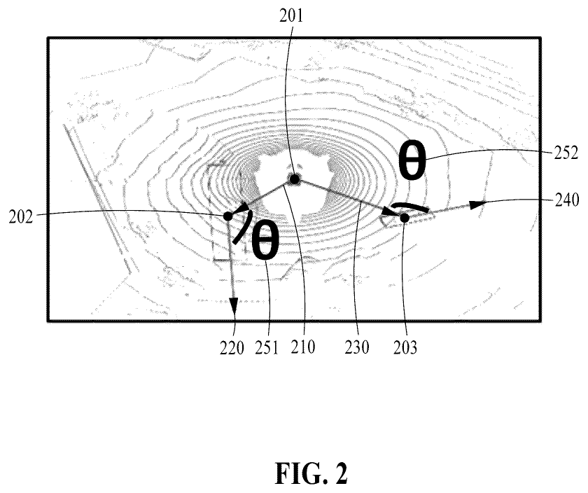

For example, referring to FIG. 2, when (1) a first angle θ 251 that is the angle between (a) an ego-first-object vector 210 (defined by a reference location 201 of the ego and a reference location 202 of a first object) and (b) a first-object motion vector 220 (motion of the first object) is (2) the same as a second angle θ 252 that is the angle between (a) an ego-second-object vector 230 (defined by the reference location 201 of the ego and a reference location 203 of a second object), and (b) a second-object motion vector 240 (motion of the second object), then point clouds with the same side of the first object and the second object may be obtained from the LiDAR sensor. For example, when a point cloud corresponding to the back side of the first object is obtained from the LiDAR sensor, a point cloud of the second object obtained from the LiDAR sensor may also correspond to the back side of the second object.

Referring back to FIG. 1, objects with the same class, the same distance from the ego, and the same angle θ as each other may be rotationally transformed based on the location of the ego and may be transformed into the angle that is the same as the angle with the ego in the extracted region. When there is no object corresponding to both the distance from the ego and the angle with the ego (which is the same as the location information about the extracted region), the target object may be set to be an object whose (i) distance from the ego corresponds to the location information about the extracted region and whose (ii) angle θ corresponds to the location information about the extracted region; in such case, the location information about the target object (in particular, its pose/rotation) may be corrected, through rotational transformation, to correspond to the location information about the extracted region.

The data augmentation method may include operation 130 of synthesizing the point cloud of the target object with the extracted (identified) region based on the point cloud of the target object and the point cloud of the target data.

For example, using a generation model for the synthesis of point clouds, a synthetic point cloud may be obtained by synthesizing (i) the point cloud of the target object with (ii) the extracted region in the point cloud of the target data.

The data augmentation method may include operation 140 of synthesizing (i) an image of the target object with (ii) the image of the target data that is based on the location information about the extracted region and the point cloud of the target object.

The region in the image of the target data that corresponds to the extracted region is a region where the image of the target object is synthesized with the image of the target data and may be referred to hereinafter as an in-painting region.

The aforementioned operation 140 of synthesizing the image of the target object may include (i) determining an in-painting region in the image of the target data based on the location information about the extracted region and (ii) synthesizing the image of the target object with the in-painting region based on the point cloud of the target object.

The determining of the in-painting region (in the image of the target data) may include determining a region in the image of the target data that corresponds to the extracted region and using same as the in-painting region, and this region may be determined based on a coordinate obtained by projecting coordinates of the point cloud of the extracted region in response to the image of the target data. In other words, the in-painting region may correspond to a region that is extracted from a 3D point cloud and is transformed to a 2D image. For example, the in-painting region may correspond to a 2D bounding box (or polygon) in which a 3D bounding box in the point cloud of the target data is projected onto a 2D plane corresponding to the image of the target data.

Operation 140 of synthesizing the image of the target object may include synthesizing (i) the image of the target object with (i) the image of the target data based on the image of the target data, the image of the target object, and the point cloud of the target object.

For example, using a generation model for synthesis of images, a synthetic image may be obtained by synthesizing the image of the target object with the region corresponding to the extracted region in the image of the target data. Based on the image of the target data, the image of the target object, and the point cloud of the target object (e.g., as inputs to the model), the generation model for the synthesis of images may output a synthetic image obtained by synthesizing (i) the image of the target object with (ii) the in-painting region in the image of the target data.

The data augmentation method may include generating, as training data (for training a neural network), (i) a synthetic point cloud generated by synthesizing the point cloud of the target object with the point cloud of the target data and/or (ii) a synthetic image generated by synthesizing the image of the target object with the image of the target data. The synthetic point cloud generated in operation 130 and/or the synthetic image generated in operation 140 may be used as training data for a neural network, i.e., may function as augmented training data.

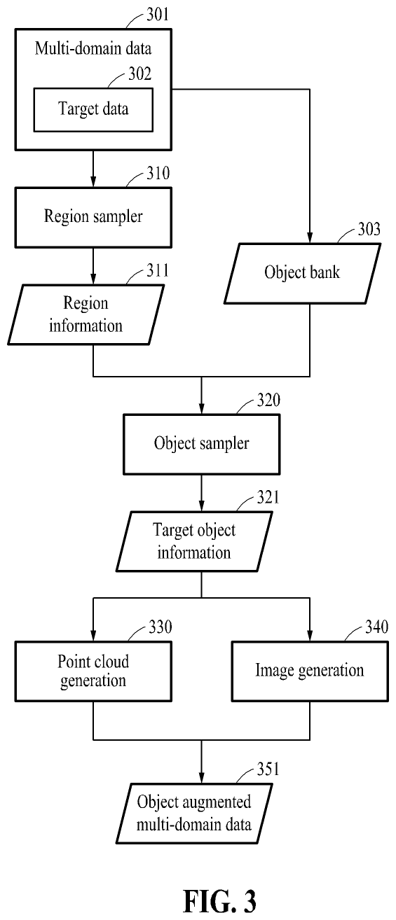

FIG. 3 illustrates an example of an apparatus for performing the data augmentation method, according to one or more embodiments.

Referring to FIG. 3, input data of the apparatus performing the data augmentation method may be multi-domain data 301, which may correspond to the above-described target data. The multi-domain data 301 may include a point cloud and an image corresponding to the point cloud. Target data 302, which is at least a portion of the multi-domain data 301, may be input to a region sampler 310.

The region sampler 310 is a module that may output region information 311 from the target data 302. The region information 311 may include information about a region extracted from the target data 302's point cloud, which may by used for object synthesis. For example, the extracted region may be delimited by a 3D bounding box. For example, the region information 311 may include location information and class information about the region. As described above, the location information about the region may include coordinate information, rotation information, and size information about the region. The class information about the region may include class information about an object included in the region or class information about an object that may be synthesized with the region.

An object bank 303 may be a database that stores information about the above-described object(s). The information about the object stored in the object bank 303 may include at least one of the point cloud of the object, the image of the object, the class information about the object, and/or the location information about the object. As described above, the location information about the object may include at least one of distance information from the ego, angle information with the ego, and/or rotation information.

The object bank 303 may extract the information about the object from the multi-domain data 301 and store the information about the object; this may be done for each object.

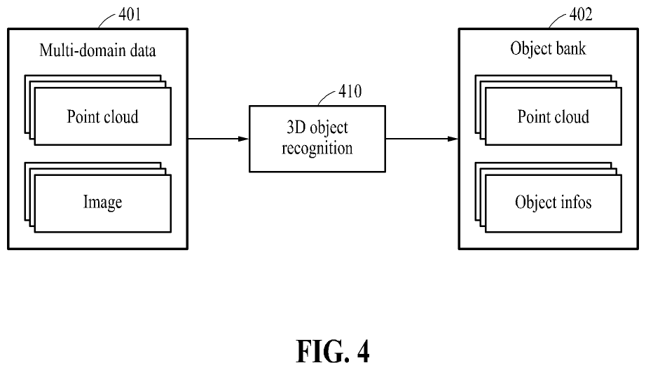

For example, referring to FIG. 4, multi-domain data 401 may include pairs of point clouds and images (images paired with respectively corresponding point clouds). The point cloud and the image included in a pair may be pieces of data that correspond to each other (e.g., captured at the same time). 3D object recognition 410 may be performed on a point cloud of the multi-domain data 401. As a result of performing the 3D object recognition 410, each object included in the point cloud of the multi-domain data 401 may be detected, and a class of each detected object may be estimated/recognized. The point cloud corresponding to each detected object may be stored in an object bank 402, and information about each detected object may be mapped to the point cloud and stored in the object bank 402. The information about the object mapped to the point cloud of the object and stored in the object bank 402 may include the image of the object, the class information about the object, and/or the location information about the object.

Referring back to FIG. 3, an object sampler 320 may extract target object information 321 from the information about the object stored in the object bank 303; the extracting may be based on the region information 311. The object sampler 320 may determine some of the objects of which the information is stored in the object bank 303 to be the target objects. Specifically, the object sampler 320 may determine, to be the target object, an object that corresponds to the region information 311 (extracted from the region sampler 310). The object sampler 320 may output the target object information 321 stored in the object bank 303.

The object sampler 320 may correct the location information about the target object by rotationally transforming the location information about the target object included in the target object information 321; the rotational transforming may be based on the location information about the extracted region. As described above, an object may be determined to be the target object when it is an object of which (A) its distance from the ego corresponds to the location information about the extracted region and of which (B) the angle θ between (i) an ego-target object (a vector defined by the reference location of the ego and the reference location of the target object) and (ii) the target-object motion vector is such that the angle θ corresponds to the location information about the extracted region may be determined. The location information about the target object may be corrected to correspond to the location information about the region extracted; the correction may be done through rotational transformation.

A point cloud generation module 330 may synthesize the point cloud of the target object with the region extracted from the region sampler 310 (which has extracted the region based on the target object information 321), and thus. The point cloud generation module 330 may output a synthetic point cloud obtained by synthesizing the point cloud of the target object included in the target object information 321 with the point cloud of the target data 302.

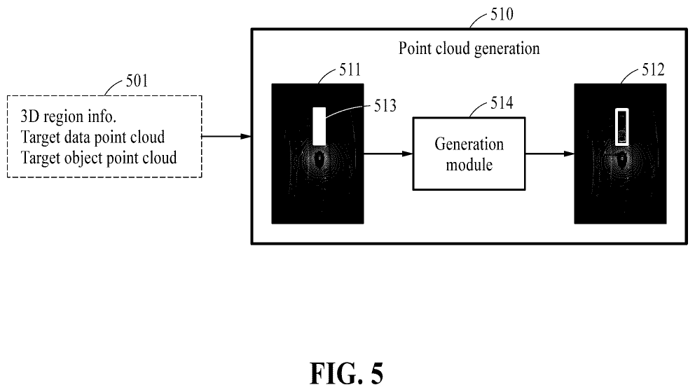

For example, referring to FIG. 5, a point cloud generation module 510 may output a synthetic point cloud 512 obtained by synthesizing the point cloud of the target object with a point cloud 511 of the target data. Input data 501 inputted to the point cloud generation module 510 may include: the information about the extracted region (i.e., 3D region info.), a target data point cloud, and a target object point cloud. The point cloud generation module 510 may include a generation module 514 to synthesize the point cloud of the target object with a region 513 in the point cloud 511 of the target data. The resulting synthetic point cloud 512 output from the generation module 514 as output data thereof.

Referring back to FIG. 3, an image generation module 340 may synthesizes the image of the target object with the image of the target data; the synthesis may be based on the target object information 321. The image generation module 340 may output a synthetic image obtained by synthesizing the image of the target object included in the target object information 321 with the image of the target data 302.

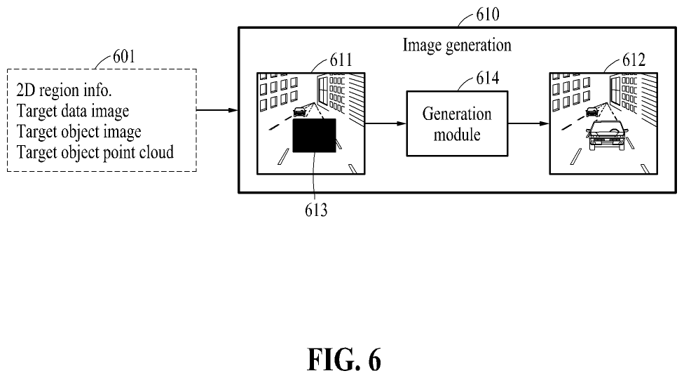

For example, referring to FIG. 6, an image generation module 610 may output a synthetic image 612 obtained by synthesizing the image of the target object with an image 611 of the target data. Input data 601 of the image generation module 610 may include: information about a region where a 3D coordinate and a 3D space of the region are transformed into a 2D coordinate and a 2D space (i.e., 2D region info.), a target data image, a target object image, and/or a target object point cloud. The 2D region info. may be an in-painting region 613, which is a partial region in the image of the target data.

The image generation module 610 may include a generation module 614 to synthesize the image of the target object with the in-painting region 613 in the image 611 of the target data. The synthetic image 612 output from the generation module 614 may correspond to output data of the image generation module 610.

Referring back to FIG. 3, object augmented multi-domain data 351 including the synthetic point cloud output from the point cloud generation module 330 and the synthetic image output from the image generation module 340 may be output data of the apparatus performing the data augmentation method. For example, the object augmented multi-domain data 351 may be included in a training data set for training a neural network. For example, the object augmented multi-domain data 351 may be included in the multi-domain data.

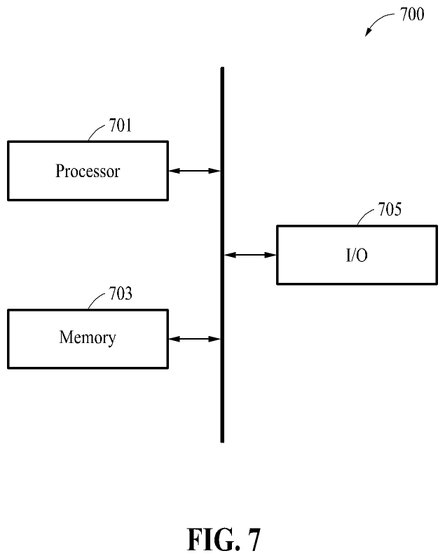

FIG. 7 illustrates an example of a data augmentation apparatus, according to one or more embodiments.

Referring to FIG. 7, a data augmentation apparatus 700 may include a processor 701 (which may be a combination of different processors), a memory 703, and an input/output (I/O) device 705. The data augmentation apparatus 700 may be used to implement the apparatus performing the data augmentation method described above with reference to FIGS. 1 to 6.

The processor 701 may perform at least one operation of the data augmentation method described above with reference to FIGS. 1 to 6. For example, the processor 701 may perform at least one operation of extracting a region for object synthesis from a point cloud of target data based on information about objects included in the target data, determining a target object based on location information about the extracted region, synthesizing a point cloud of the target object with the region based on the point cloud of the target object and the point cloud of the target data, or synthesizing an image of the target object with an image of the target data based on the location information about the extracted region and the point cloud of the target object.

The memory 703 may be a volatile memory or a non-volatile memory (but not a signal per se) and may store the data related to the data augmentation method described above with reference to FIGS. 1 to 6. For example, the memory 703 may store data generated during the process of performing the data augmentation method or data necessary for performing the data augmentation method. For example, the memory 703 may store multi-domain data. For example, the memory 703 may store the information about the extracted region and the information about the target object. For example, the memory 703 may correspond to the above-described database or the object bank 303 in FIG. 3.

The data augmentation apparatus 700 may be connected to an external device (e.g., a personal computer (PC) or a network) through the I/O device 705 and exchange data with the external device. For example, the data augmentation apparatus 700 may receive target data, which is multi-domain data, through the I/O device 705 and may output a synthetic point cloud and a synthetic image.

The memory 703 may not be a component of the data augmentation apparatus 700 and may be included in an external device accessible by the data augmentation apparatus 700. In this case, the data augmentation apparatus 700 may receive data stored in the memory 703 included in the external device and transmit data to be stored in the memory 703 through a communication module. For example, the above-described database or the object bank 303 in FIG. 3 may be stored in an external memory of the data augmentation apparatus 700 rather than the memory 703.

The memory 703 may store a program configured to implement the data augmentation method described above with reference to FIGS. 1 to 6. The processor 701 may execute a program stored in the memory 703 and may control the data augmentation apparatus 700. Code of the program executed by the processor 701 may be stored in the memory 703.

The data augmentation apparatus 700 may further include other components not shown in the diagram. For example, the data augmentation apparatus 700 may include a communication module. The communication module may provide a function for the data augmentation apparatus 700 to communicate with another electronic device or another server through a network. That is, the data augmentation apparatus 700 may be connected to an external device (e.g., a terminal of a user, a server, or a network) through the communication module and exchange data with the external device. In addition, for example, the data augmentation apparatus 700 may further include other components such as a transceiver, various sensors, and a database.

The computing apparatuses, the electronic devices, the processors, the memories, the image sensors, the neural networks, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of augmenting data performed by a computing device, the method comprising:
based on information about objects comprised in target data, extracting a region for object synthesis from a point cloud of the target data;
determining a target object based on location information about the extracted region;
based on a point cloud of the target object and the point cloud of the target data, synthesizing the point cloud of the target object with the extracted region to generate a synthetic point cloud; and
generating a synthetic image by synthesizing an image of the target object with an image of the target data based on the location information about the extracted region and the point cloud of the target object, wherein the synthetic point cloud and the synthetic image form an augmented training item.

2. The method of claim 1, wherein the region is extracted from the point cloud of the target data based on segmentation information about the point cloud of the target data.

3. The method of claim 1, wherein the extracting of the region comprises:
determining a class of an object to be synthesized with the target data; and
extracting a region for object synthesis from the target data based on locations of objects comprised in the target data that are associated with the determined class.

4. The method of claim 1, wherein the location information about the extracted region comprises coordinate information, rotation information, and size information about the extracted region.

5. The method of claim 1, wherein the determining of the target object comprises, among objects of which a point cloud and location information are stored in a database, selecting, to be the target object, an object based on the object having location information that corresponds to the location information about the extracted region.

6. The method of claim 5, wherein the location information about the object stored in the database comprises distance information and angle information from an ego.

7. The method of claim 1, wherein the determining of the target object comprises correcting location information about the target object by rotationally transforming the location information about the target object based on the location information about the extracted region,
wherein an angle between a first vector and a progress vector of the target object and distance information between the target object and the ego correspond to the location information about the extracted region, wherein the first vector is defined by a reference location of an ego and a reference location of the target object.

8. The method of claim 1, wherein the synthesizing of the image of the target object with the image of the target data is based on the image of the target data, the image of the target object, and the point cloud of the target object.

9. The method of claim 1, wherein the synthesizing of the image of the target object with the image of the target data comprises:
determining an in-painting region in the image of the target data based on the location information about the extracted region; and
synthesizing the image of the target object with the in-painting region based on the point cloud of the target object.

10. The method of claim 9, wherein the determining of the in-painting region in the image of the target data comprises determining a region, corresponding to the extracted region, in the image of the target data to be the in-painting region based on a coordinate obtained by projecting a coordinate of a point cloud of the extracted region based on the image of the target data.

11. The method of claim 1, further comprising:
generating at least one of a synthetic point cloud generated by synthesizing the point cloud of the target object with the point cloud of the target data or a synthetic image generated by synthesizing the image of the target object with the image of the target data as training data of a neural network.

12. A non-transitory computer-readable storage medium storing instructions that, when executed by a processor, cause the processor to perform the method of claim 1.

13. An apparatus for augmenting training data, the apparatus comprising:
one or more processors:
memory storing instructions configured to cause the one or more processors to:
based on information about objects comprised in target data, extract a region for object synthesis from a point cloud of the target data;
determine a target object based on location information about the extracted region;
based on a point cloud of the target object and the point cloud of the target data, synthesize the point cloud of the target object with the extracted region to generate a synthetic point cloud; and
generate a synthetic image by synthesizing an image about the target object with an image of the target data based on the location information about the extracted region and the point cloud of the target object, wherein the synthetic point cloud and the synthetic image form an augmented training item.

14. The apparatus of claim 13, wherein the instructions are further configured to cause the one or more processors to extract the region from the point cloud of the target data based on segmentation information about the point cloud of the target data.

15. The apparatus of claim 13, wherein the instructions are further configured to cause the one or more processors to, in the extracting of the region:
determine a class of an object to be synthesized with the target data; and
extract a region for object synthesis from the target data based on locations of objects comprised in the target data that are associated with the determined class.

16. The apparatus of claim 13, wherein the instructions are further configured to cause the one or more processors to, in the determining of the target object, among objects of which a point cloud and location information are stored in a database, select, to be the target object, an object based on the object having location information that corresponds to the location information about the extracted region.

17. The apparatus of claim 13, wherein the instructions are further configured to cause the one or more processors to, in the determining of the target object, correct location information about the target object by rotationally transforming the location information about the target object based on the location information about the extracted region,
wherein an angle between a first vector and a progress vector of the target object and distance information between the target object and the ego correspond to the location information about the extracted region, wherein the first vector is defined by a reference location of an ego and a reference location of the target object.

18. The apparatus of claim 13, wherein the instructions are further configured to cause the one or more processors to, in the synthesizing of the image of the target object with the image of the target data:
determine an in-painting region in the image of the target data based on the location information about the extracted region; and
synthesize the image of the target object with the in-painting region based on the point cloud of the target object.

19. The apparatus of claim 18, wherein the instructions are further configured to cause the one or more processors to, in the determining of the in-painting region in the image of the target data, determine a region corresponding to the extracted region in the image of the target data to be the in-painting region based on a coordinate obtained by projecting a coordinate of a point cloud of the extracted region based on the image of the target data.

20. The apparatus of claim 13, wherein the instructions are further configured to cause the one or more processors to generate at least one of a synthetic point cloud generated by synthesizing the point cloud of the target object with the point cloud of the target data or a synthetic image generated by synthesizing the image of the target object with the image of the target data as training data of a neural network.
